(19) United States
(12) Patent Application Publication
(10) Pub. No.: US 2019/0319938 A1
(43) Pub. Date: Oct. 17, 2019

(54) NETWORK AUTHENTICATION FOR REAL-TIME INTERACTION USING PRE-AUTHORIZED DATA RECORD

(71) Applicant: Bank of America Corporation, Charlotte, NC (US)

(72) Inventors: Joseph Benjamin Castinado, North Glenn, CO (US); Charles Russell Kendall, Snoqualmie, WA (US)

(21) Appl. No.: 15/952,095

(22) Filed: Apr. 12, 2018

(51) Int. Cl. H04L 29/06; H04L 9/06; G06Q 20/40

(52) U.S. Cl. CPC H04L 63/083; G06Q 2220/00; G06Q 20/401; H04L 9/0637

(57) ABSTRACT

Embodiments of the present invention provide a system operatively connected with a block chain distributed network and for using the block chain distributed network for facilitating network authentication for real-time interactions using pre-authorized data records. Embodiments receive, at a node of a block chain distributed network, an authentication record associated with a user of a data network; access a distributed ledger, wherein the distributed ledger is updated based on communications from the block chain distributed network; determine, from the distributed ledger, whether the authentication record includes effective authentication token; if so, authenticate the user using the authentication token; if not request credentials from the user; receive the credentials from the user; authenticate the credentials; and create an authenticated token based on the authenticated credentials; and record the authenticated token as an updated authentication record on the distributed ledger.

### FIELD

The present invention relates to improving network authentication.

### BACKGROUND

Present systems require full authentication for each and every transaction requested. Therefore, a need for reduced or eliminated authentication for subsequent transactions is needed.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Embodiments of the present invention address the above needs and/or achieve other advantages by providing apparatuses (e.g., a system, computer program product and/or other devices) and methods for network authentication for real-time interactions using pre-authorized data records. The system embodiments may comprise one or more memory devices having computer readable program code stored thereon, a communication device, and one or more processing devices operatively coupled to the one or more memory devices.

Embodiments of the present invention provide a system operatively connected with a block chain distributed network and for using the block chain distributed network for network authentication for real-time interactions using pre-authorized data records. Embodiments receive, at a node of a block chain distributed network, an authentication record associated with a user of a data network; access a distributed ledger, wherein the distributed ledger is updated based on communications from the block chain distributed network; determine, from the distributed ledger, whether the authentication record includes effective authentication token; if so, authenticate the user using the authentication token; if not request credentials from the user; receive the credentials from the user; authenticate the credentials; and create an authenticated token based on the authenticated credentials; and record the authenticated token as an updated authentication record on the distributed ledger.

In some embodiments, the processing device is further configured to execute computer-readable program code to receive a requests from a user to perform a transaction; and in response to receiving the request to perform the transaction, access the distributed ledger to determine whether the authentication record includes effective authentication token. In some such embodiments, the processing device is further configured to execute computer-readable program code to in response to determining that the authentication record includes an effective authentication token, establish authentication of the user for a predetermined time period, whereby subsequent transaction requests received within the predetermined time period do not require re-authentication.

In other such embodiments, the processing device is further configured to execute computer-readable program code to in response to determining that the authentication record includes an effective authentication token, establish authentication of the user for a predetermined time period, whereby subsequent transaction requests received within the predetermined time period do not require complete re-authentication. In some of these embodiments, the processing device is further configured to execute computer-readable program code to in response to receiving a second transaction request associated with a second transaction, requesting less than full authentication credentials for re-authentication of the user; receiving the less than full authentication credentials from the user; and re-authenticating the user to perform the second transaction.

In some embodiments, the processing device is further configured to execute computer-readable program code to in response to determining that the authentication record includes an effective authentication token, establish authentication of the user for a predetermined type of transaction, whereby subsequent transaction requests received that match the predetermined type of transaction do not require complete re-authentication.

In some embodiments, the processing device is further configured to execute computer-readable program code to record the updated authentication record on a second distributed ledger different than the distributed ledger.

In some embodiments, the processing device is further configured to execute computer-readable program code to access a set of rules configured to cause the system to access the updated authentication record to facilitate performance of a real-time interaction.

According to embodiments of the invention, a computer program product for using a block chain distributed network for network authentications for real-time interaction using pre-authorized data records has at least one non-transitory computer readable medium with computer readable instructions, the instructions, when executed by a computer processor, cause the computer processor to receive, at a node of a block chain distributed network, an authentication record associated with a user of a data network; access a distributed ledger, wherein the distributed ledger is updated based on communications from the block chain distributed network; determine, from the distributed ledger, whether the authentication record includes effective authentication token; if so, authenticate the user using the authentication token; if not request credentials from the user; receive the credentials from the user; authenticate the credentials; and create an authenticated token based on the authenticated credentials; and record the authenticated token as an updated authentication record on the distributed ledger.

In some embodiments, the computer readable instructions further cause the computer processor to receive a requests from a user to perform a transaction; and in response to receiving the request to perform the transaction, access the distributed ledger to determine whether the authentication record includes effective authentication token.

In some such embodiments, the computer readable instructions further cause the computer processor to in response to determining that the authentication record includes an effective authentication token, establish authentication of the user for a predetermined time period, whereby subsequent transaction requests received within the predetermined time period do not require re-authentication.

In other such embodiments, the computer readable instructions further cause the computer processor to in response to determining that the authentication record includes an effective authentication token, establish authentication of the user for a predetermined time period, whereby subsequent transaction requests received within the predetermined time period do not require complete re-authentication. In other such embodiments, the computer readable instructions further cause the computer processor to in response to receiving a second transaction request associated with a second transaction, requesting less than full authentication credentials for re-authentication of the user; receiving the less than full authentication credentials from the user; and re-authenticating the user to perform the second transaction.

In some embodiments, the computer readable instructions further cause the computer processor to in response to determining that the authentication record includes an effective authentication token, establish authentication of the user for a predetermined type of transaction, whereby subsequent transaction requests received that match the predetermined type of transaction do not require complete re-authentication.

In some embodiments the computer readable instructions further cause the computer processor to record the updated authentication record on a second distributed ledger different than the distributed ledger.

In some embodiments, the computer readable instructions further cause the computer processor to access a set of rules configured to cause the system to access the updated authentication record to facilitate performance of a real-time interaction.

According to embodiments of the invention, a computer implemented method for using the block chain distributed network for network authentication for real-time interactions using pre-authorized data records, the computer implemented method comprising receiving, at a node of a block chain distributed network, an authentication record associated with a user of a data network; accessing a distributed ledger, wherein the distributed ledger is updated based on communications from the block chain distributed network; determining, from the distributed ledger, whether the authentication record includes effective authentication token; if so, authenticating the user using the authentication token; if not requesting credentials from the user; receiving the credentials from the user; authenticating the credentials; and creating an authenticated token based on the authenticated credentials; and recording the authenticated token as an updated authentication record on the distributed ledger.

In some embodiments, the method includes receiving requests from a user to perform a transaction; and in response to receiving the request to perform the transaction, accessing the distributed ledger to determine whether the authentication record includes effective authentication token.

In some embodiments, in response to determining that the authentication record includes an effective authentication token, the method includes establishing authentication of the user for a predetermined time period, whereby subsequent transaction requests received within the predetermined time period do not require re-authentication.

In some embodiments, in response to determining that the authentication record includes an effective authentication token, the method also includes establishing authentication of the user for a predetermined time period, whereby subsequent transaction requests received within the predetermined time period do not require complete re-authentication.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1A illustrates a diagram illustrating a system for network authentication for real-time interaction using pre-authorized data record.

FIG. 1B illustrates a block diagram illustrating the real-time interaction system environment, in accordance with embodiments of the present invention.

FIG. 2A illustrates a traditional centralized ledger system.

FIG. 2B is a diagram illustrating a distributed ledger system used in embodiments of the invention.

FIG. 3 is a diagram illustrating a blockchain distributed ledger system according to embodiments of the invention.

FIG. 4 is a flowchart illustrating a method for network authentication for real-time interaction using pre-authorized data record according to embodiments of the invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Systems, methods, and computer program products are herein disclosed that provide for As used herein, a “real-time interaction” refers to a resource transfer between users and/or entities participating in and leveraging a settlement network operating in real or near real-time (e.g., twenty-four hours a day, seven days a week), wherein settlement of the interaction occurs at or very close in time to the time of the interaction. A real-time interaction may include a payment, wherein a real-time interaction system enables participants to initiate credit transfers, receive settlement for credit transfers, and make available to a receiving participant funds associated with the credit transfers in real-time, wherein the credit transfer may be final and irrevocable. Real-time interactions or payments provide marked improvements over conventional interaction clearing and payment settlement methods (e.g., automated clearing house (ACH), wire, or the like) which can require several hours, days, or longer to receive, process, authenticate a payment, and make funds available to the receiving participant which may, in total, require several back-and-forth communications between involved financial institutions. In some cases, conventional settlement methods may not be executed until the end of the business day (EOB), wherein payments are settled in batches between financial institutions.

Real-time interactions reduce settlement time by providing pre-authentication or authentication at the time of a requested interaction in order to enable instantaneous or near-instantaneous settlement between financial institutions at the time of the interaction, wherein resources or funds may be made immediately available to a receiving participant (i.e., payee) following completion of the interaction. Examples of real-time interactions include business to business interactions (e.g., supplier payments), business to consumer interactions (e.g., legal settlements, insurance claims, employee wages), consumer to business interactions (e.g., bill pay, hospital co-pay, payment at point-of-sale), and peer to peer (P2P) interactions (e.g., repayment or remittance between friends and family). In a specific example, a real-time interaction may be used for payment of a utility bill on the due date of the bill to ensure payment is received on-time and accruement of additional fees due to late payment is avoided. In another example, real-time interactions may be especially beneficial for small entities and users (e.g., small merchants/businesses) that may have a heavier reliance on short-term funds and may not prefer to wait days for transaction settlements.

Real-time interactions not only provide settlement immediacy, but also provide assurance, fraud reduction, and bank-grade security to payments due to the inherent nature of the payment and user authentication infrastructure. Further, real-time interactions may reduce payment processing costs due to the simplified nature of required communication when compared to conventional settlement methods. In some embodiments, real-time interaction systems further include information and conversation tools that financial institutions may utilize to enhance a settlement experience for participants.

A system leveraging a real-time interaction settlement network allows for an interaction, transaction, payment, or the like to be completed between participating parties (e.g., financial institutions and/or their customers) via an intermediary clearing house acting in the role of a neutral party. Participant accounts are held at the clearing house and administered by both the participant and the clearing house. In this way, the clearing house is able to transfer resources or funds between the participant accounts on behalf of the participants in order to settle interactions.

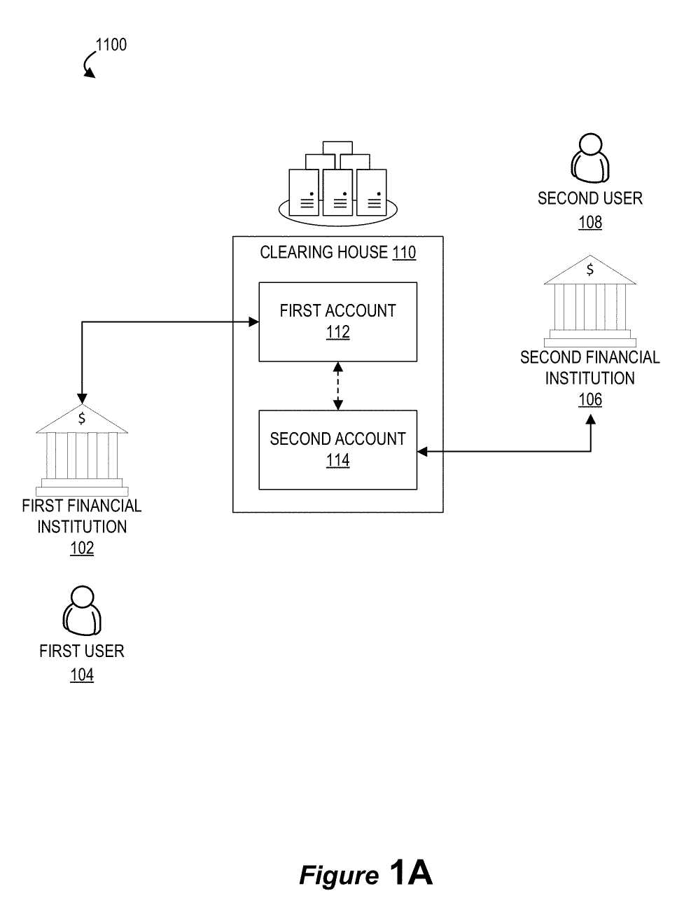

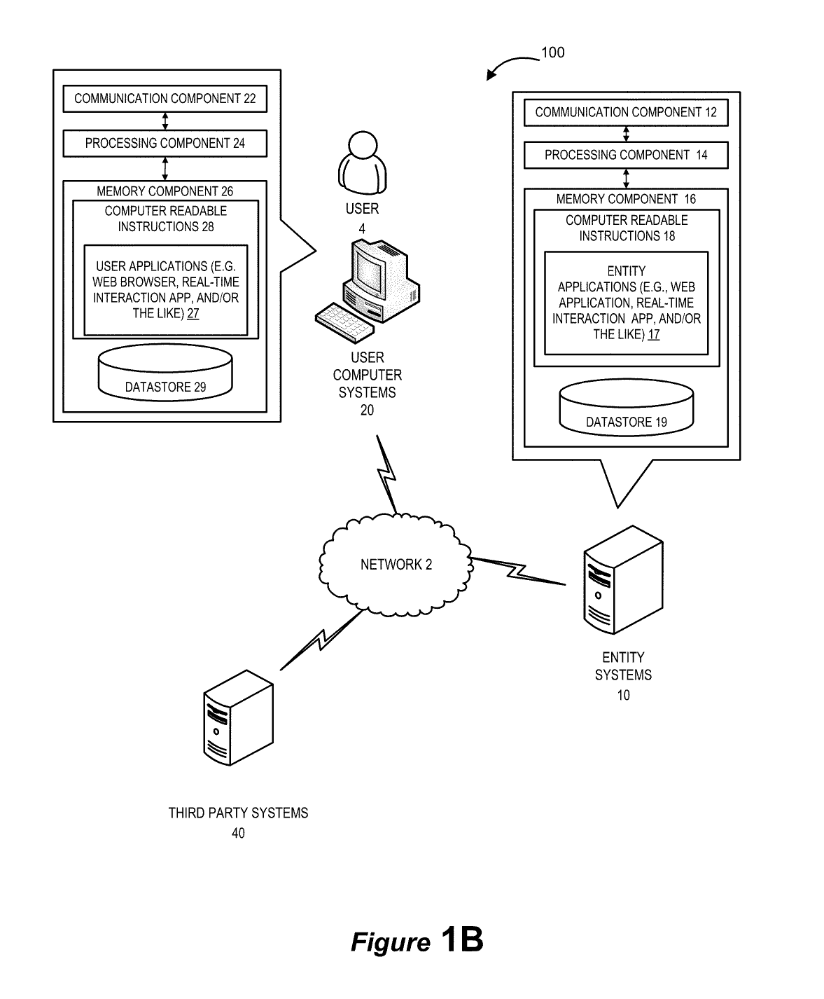

FIG. 1A illustrates a block diagram of a high-level real-time interaction flow environment 1100, in accordance with one embodiment of the invention. In the illustrated environment, a first user 104 is associated with (i.e., a customer of) a first financial institution 102 and a second user 108 is associated with a second financial institution 106. A clearing house 110 comprises a first account 112 associated with the first financial institution 102 and a second account 114 associated with the second financial institution 106. The first account 112 and the second account 114 are accessible by each associated financial institution and the clearing house 110 which acts as a trusted intermediary during settlement between the financial institutions. Resources or funds may be transferred by each financial institution to and from their associated account. Transfers between the first account 112 and the second account 114 are administered by the clearing house 110 pending authentication and authorization by participating parties of each transfer.

In one embodiment, the first user 104 and the second user 108 are participants of a real-time interaction system, wherein the first user 104 (i.e., the payor) initiates a credit transfer to the second user 108 (i.e., the payee). In a specific example, the first user 104 is required to initiate the transfer from the first financial institution 102, wherein the first user 104 provides authentication information to authenticate the identity of the first user 104 and to validate that an account of the first user 104 held at the first financial institution 102 contains at least a sufficient amount of available funds to fulfill the transfer. While in one embodiment, the first user 104 is required to initiate the transfer from a physical, brick-and-mortar location of the first financial institution 102, in alternative embodiments described herein, the transfer may be initiated from other locations wherein a user is not required to be at a brick-and-mortar location (e.g., via an electronic application, a website, or the like).

The first user 104, as the sending participant (i.e., payor), is required to authenticate his or her identity by providing information or credentials to the associated financial institution. For example, authentication information may include account numbers, routing numbers, PIN numbers, username and password, date of birth, social security number, or the like, or other authentication information as described herein. In some embodiments, authentication may comprise multi-factor or multi-step authentication in accordance with information security standards and requirements.

Upon initiating an interaction, the first user 104 becomes obligated to pay the amount of the interaction, wherein the interaction cannot be canceled by the first user 104 following initiation and transmission of communication to a receiving participant. The second user 108, as the receiving participant (i.e., the payee), receives communication to accept payment following similar user authentication requirements. Communication between participants for the interaction is transmitted between the financial institutions via the clearing house 110 which directs the payment to the appropriate financial institution associated with the receiving participant. The transfer of funds occurs between the financial institution accounts 112 and 114 associated with the financial institutions 102 and 106 on behalf of their associated users, wherein the interaction may be settled immediately, concurrent with the interaction. As settlement occurs between the representative financial institutions, debiting and crediting of individual user accounts may be managed at each financial institution with their associated customers. As the interaction is settled immediately, funds may be made available for use in real or near real-time.

It should be understood that while the illustrated embodiment of FIG. 1A depicts only first and second users, financial institutions, and accounts, other embodiments of a real-time interaction network may comprise a plurality of accounts associated with a plurality financial institutions. In some embodiments, the environment 1100 may further comprise more than one clearing house 110 (e.g., TCH, the Federal Reserve, and the like) that receive and process interaction requests as described herein. Financial institutions may include one or more community banks, regional banks, credit unions, corporate banks, direct connect financial institutions, and the like.

In accordance with embodiments of the invention, the terms “entity system” may include any organization such as one that processes financial transactions including, but not limited to, banks, credit unions, savings and loan associations, card associations, settlement associations, investment companies, stock brokerages, asset management firms, insurance companies and the like. Furthermore, embodiments of the present invention use the term “user” or “customer.” It will be appreciated by someone with ordinary skill in the art that the user or customer may be a customer of the financial institution or a potential customer of the financial institution or an employee of the financial institution.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, personal computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

FIG. 1B illustrates a network authentication for real-time interactions environment 100, in accordance with embodiments of the invention. As illustrated in FIG. 1B, one or more entity systems 10 are operatively coupled, via a network 2, to user computer systems 20, a plurality of user computer systems, and/or one or more other systems (not illustrated). In this way, the user 4 (e.g., one or more associates, employees, agents, contractors, sub-contractors, third-party representatives, customers, or the like), through a user application 27 (e.g., web browser, real-time interaction application, or the like), may access entity applications 17 (e.g., website, real-time interaction application, or the like) of the entity systems 10 to perform authentication using distributed ledgers as discussed herein. In some embodiments, the real-time interaction application may be a part of an independent real-time interaction system. In such an embodiment, the independent real-time interaction system is maintained and operated by the entity systems 10. The independent real-time interaction system may comprise one or more processing devices operatively coupled to the one or more memory devices and configured to execute computer readable code stored in the one or more memory devices.

The network 2 may be a global area network (GAN), such as the Internet, a wide area network (WAN), a local area network (LAN), or any other type of network or combination of networks. The network 2 may provide for wireline, wireless, or a combination of wireline and wireless communication between systems, services, components, and/or devices on the network 2.

As illustrated in FIG. 1B, the entity systems 10 generally comprise one or more communication components 12, one or more processing components 14, and one or more memory components 16. The one or more processing components 14 are operatively coupled to the one or more communication components 12 and the one or more memory components 16. As used herein, the term “processing component” generally includes circuitry used for implementing the communication and/or logic functions of a particular system. For example, a processing component 14 may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more processing components 14 may include functionality to operate one or more software programs based on computer-readable instructions 18 thereof, which may be stored in the one or more memory components 16.

The one or more processing components 14 use the one or more communication components 12 to communicate with the network 2 and other components on the network 2, such as, but not limited to, the components of the user computer systems 20, third-party systems 40, or other systems. As such, the one or more communication components 12 generally comprise a wireless transceiver, modem, server, electrical connection, electrical circuit, or other component for communicating with other components on the network 2. The one or more communication components 12 may further include an interface that accepts one or more network interface cards, ports for connection of network components, Universal Serial Bus (USB) connectors and the like. In one embodiment of the present invention, the one or more processing components 14 automatically implement a distributed ledger used for tracking balances as between an entity and third parties.

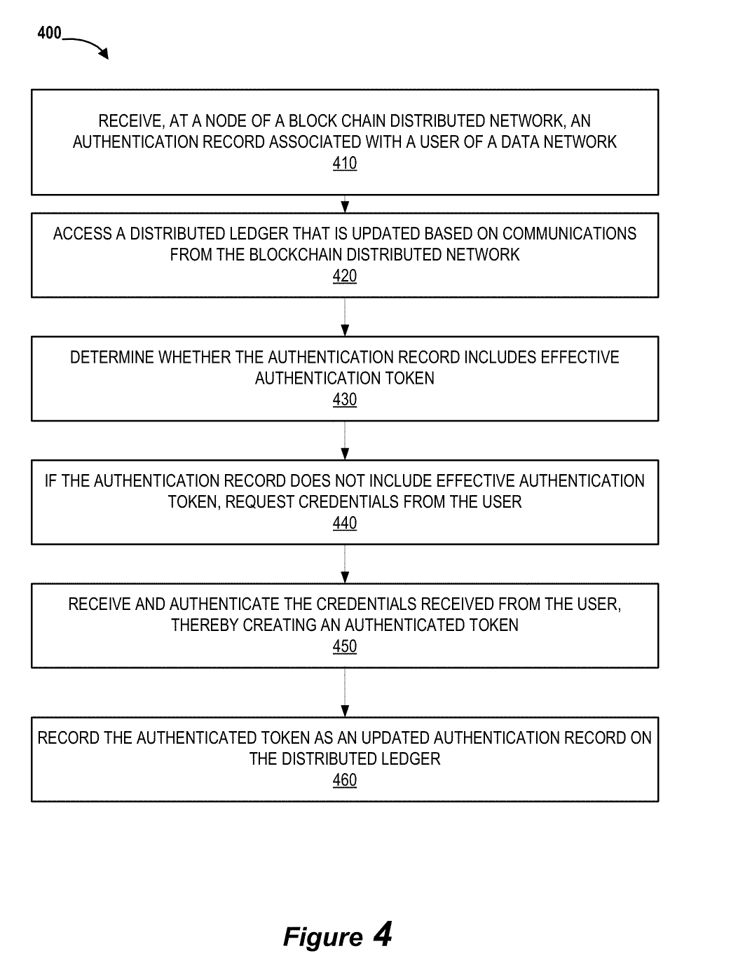

As further illustrated in FIG. 1, the entity systems 10 comprise computer-readable instructions 18 stored in the memory component 16, which in one embodiment includes the computer-readable instructions 18 of the entity application 17 (e.g., website application, real-time interaction application, and/or the like). In some embodiments, the one or more memory components 16 include one or more data stores 19 for storing data related to the entity systems 10, including, but not limited to, data created, accessed, and/or used by the entity application 17. The one or more data stores may store the copies of the distributed ledger, historical data, and/or other information. In one embodiment of the present invention, the real-time interaction application comprises a rules engine to perform one or more steps described in the process flows of FIG. 4.

As illustrated in FIG. 1B, users 4 may access the application 17, or other applications, through a user computer system 20. The user computer system 20 may be a desktop, mobile device (e.g., laptop, smartphone device, PDA, tablet, or other mobile device), or any other type of computer that generally comprises one or more communication components 22, one or more processing components 24, and one or more memory components 26.

The one or more processing components 24 are operatively coupled to the one or more communication components 22 and the one or more memory components 26. The one or more processing components 24 use the one or more communication components 22 to communicate with the network 2 and other components on the network 2, such as, but not limited to, the user computer systems 20, third party systems 40, and/or other systems. As such, the one or more communication components 22 generally comprise a wireless transceiver, modem, server, electrical connection, or other component for communicating with other components on the network 2. The one or more communication components 22 may further include an interface that accepts one or more network interface cards, ports for connection of network components, Universal Serial Bus (USB) connectors and the like. Moreover, the one or more communication components 22 may include a keypad, keyboard, touch-screen, touchpad, microphone, mouse, joystick, other pointer component, button, soft key, and/or other input/output component(s) for communicating with the users 4. In one embodiment of the present invention, the real-time interaction application in the user computer systems 20, the third party systems 40, and the entity systems 10 may comprise a special interaction interface to display information associated with the one or more distributed ledgers, the balances of the accounts for each third party, the process steps discussed herein and the automatic actions that may be taken in response to the interaction processes discussed herein. Such information may be displayed to the user and the interface may receive information associated with the rules and/or the one or more distributed ledgers or otherwise from the user.

As illustrated in FIG. 1B, the user computer systems 20 may have computer-readable instructions 28 stored in the one or more memory components 26, which in one embodiment includes the computer-readable instructions 28 for user applications 27, such as real-time interaction application (e.g., apps, applet, or the like), portions of real-time interaction application, a web browser or other apps that allow the user 4 to take various actions, including allowing the user 4 to access applications located on other systems, or the like. In some embodiments, the user 4 utilizes the user applications 27, through the user computer systems 20, to access the entity applications 17 to perform interaction transactions or analysis. The third party systems 40 associated with a plurality of user 5 may include similar structure as that of the user computer systems 20.

Some embodiments of this invention utilize a distributed ledger, such as a distributed ledger as used in a block chain infrastructure. Block chain may use a specialized distributed ledger system for storing each process point of the complete payment structure for each transaction together in a block chain style format. The blocks store data packets of information pertaining to the processing of that particular transaction within the process and are chained together to form a time stamped historic record of the transaction processed from the client origination to external clearing. Using metadata the system allows for searching and finding complex tracking and tracing across individual transactions or accounts.

“Block chain” as used herein refers to a decentralized electronic ledger of data records which are authenticated by a federated consensus protocol. Multiple computer systems within the block chain, referred to herein as “nodes” or “compute nodes,” each comprise a copy of the entire ledger of records. Nodes may write a data “block” to the block chain, the block comprising data regarding a transaction. In some embodiments, only miner nodes may write transactions to the block chain. In other embodiments, all nodes have the ability to write to the block chain. In some embodiments, the block may further comprise a time stamp and a pointer to the previous block in the chain. In some embodiments, the block may further comprise metadata indicating the node that was the originator of the transaction. In this way, the entire record of transactions is not dependent on a single database which may serve as a single point of failure; the block chain will persist so long as the nodes on the block chain persist. A “private block chain” is a block chain in which only authorized nodes may access the block chain. In some embodiments, nodes must be authorized to write to the block chain. In some embodiments, nodes must also be authorized to read from the block chain. Once a transactional record is written to the block chain, it will be considered pending and awaiting authentication by the miner nodes in the block chain.

“Miner node” as used herein refers to a networked computer system that authenticates and verifies the integrity of pending transactions on the block chain. The miner node ensures that the sum of the outputs of the transaction within the block matches the sum of the inputs. In some embodiments, a pending transaction may require validation by a threshold number of miner nodes. Once the threshold number of miners has validated the transaction, the block becomes an authenticated part of the block chain. By using this method of validating transactions via a federated consensus mechanism, duplicate or erroneous transactions are prevented from becoming part of the accepted block chain, thus reducing the risk of data record tampering and increasing the security of the transactions within the system.

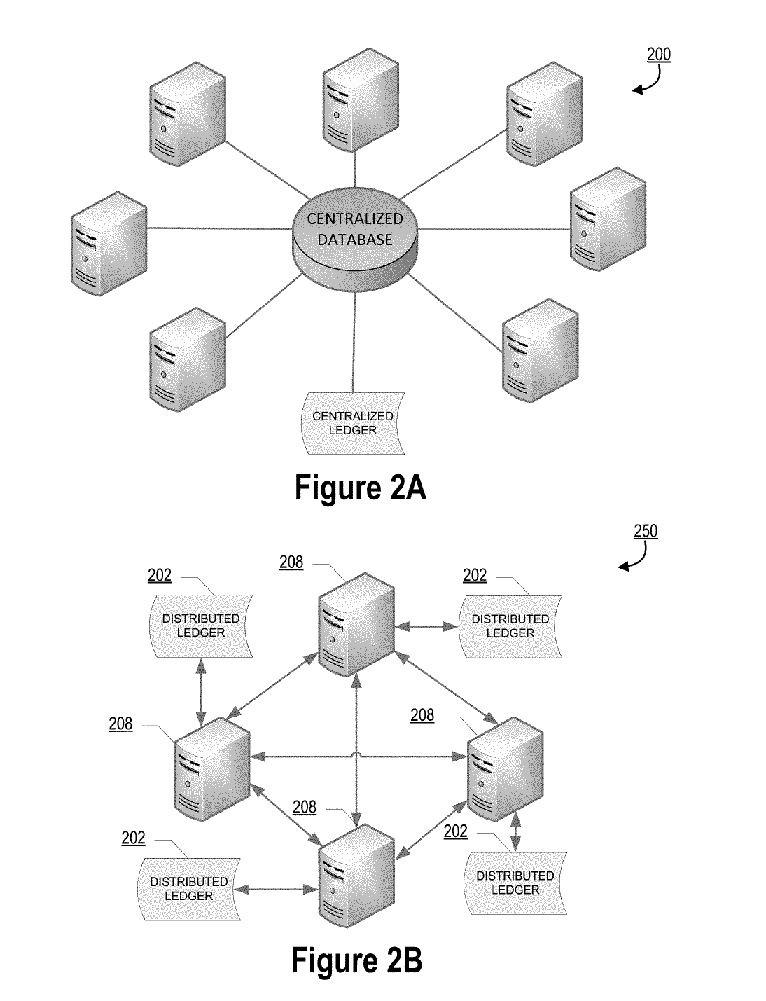

FIG. 2A illustrates a centralized database architecture environment 200, in accordance with one embodiment of the present invention. The centralized database architecture comprises multiple nodes from one or more sources and converge into a centralized database. The system, in this embodiment, may generate a single centralized ledger for data received from the various nodes. The single centralized ledger for data provides a difficult avenue for reviewing a record of a single transaction or payment process as it moves through the various applications for processing. There is no means to track the individual payment through the process at any point until it has been completely posted. Even at that point, with the amount of data a centralized database digests regularly in a complex payment structure, the ability to accurately track and trace a single transaction point or account through the process is not possible.

FIG. 2B provides a general block chain system environment architecture 250, in accordance with one embodiment of the present invention. Rather than utilizing a centralized database of data for instrument conversion, as discussed above in FIG. 2A, various embodiments of the invention may use a decentralized block chain configuration or architecture as shown in FIG. 2B in order to facilitate the converting of an instrument from a non-secured or secured format to a verified secured format. Such a decentralized block chain configuration ensures accurate mapping of resources available within an account associated with an instrument. Accordingly, a block chain configuration may be used to maintain an accurate ledger of transactions and the processing of each transaction through the processing applications by generation of a time stamped block and building of one or more blocks for each stage of the processing for the transaction. In this way, the system builds a traceable and trackable historic view of each transaction within each account, capable of being searched and identified.

A block chain is a distributed database that maintains a list of data records, such as real-time resource availability associated with one or more accounts or the like, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies. The data records recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger. As such, the status of the instrument and the resources associated therewith can be validated and cleared by one participant.

The block chain system typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person, and blocks are created by users known as “miners” who use specialized software/equipment to create blocks. In some embodiments, the block chain system is closed, as such the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases that meets other criteria.

As mentioned above and referring to FIG. 2B, a block chain system 250 is typically decentralized—meaning that a distributed ledger 202 (i.e., a decentralized ledger) is maintained on multiple nodes 408 of the block chain 250. One node in the block chain may have a complete or partial copy of the entire ledger or set of transactions and/or blocks on the block chain. Transactions are initiated at a node of a block chain and communicated to the various nodes of the block chain. Any of the nodes can validate a transaction, add the transaction to its copy of the block chain, and/or broadcast the transaction, its validation (in the form of a block) and/or other data to other nodes. This other data may include time-stamping, such as is used in cryptocurrency block chains. In some embodiments, the nodes 208 of the system might be financial institutions that function as gateways for other financial institutions. For example, a credit union might hold the account, but access the distributed system through a sponsor node.

Various other specific-purpose implementations of block chains have been developed. These include distributed domain name management, decentralized crowd-funding, synchronous/asynchronous communication, decentralized real-time ride sharing and even a general purpose deployment of decentralized applications.

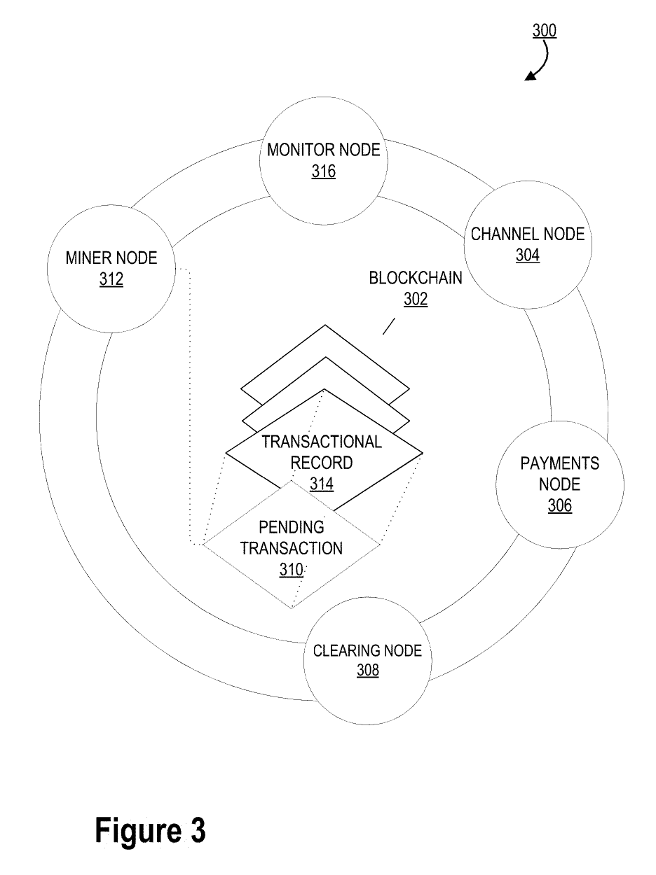

FIG. 3 provides a high level process flow illustrating node interaction within a block chain system environment architecture 300, in accordance with one embodiment of the present invention. As illustrated and discussed above, the block chain system may comprise at least one or more nodes used to generate blocks and process transactional records for generation of the life-cycle record recreation.

In some embodiments, the channel node 304, payments node 306, or the clearing node 308 may publish a pending transaction 310 to the block chain 302. At this stage, the transaction has not yet been validated by the miner node(s) 312, and the other nodes will delay executing their designated processes. The miner node 312 may be configured to detect a pending transaction 310 or steps in the processing of the payment transaction in the block chain and conduct its processes to evaluate the validity of the data therein. Upon verifying the integrity of the data in the pending transaction 310, the miner node 312 validates the transaction and adds the data as a transactional record 314, which is referred to as a block in some embodiments of the application, to the block chain 302. Once a transaction has been authenticated in this manner, the nodes will consider the transactional record 314 to be valid and thereafter execute their designated processes accordingly. The transactional record 314 will provide information about what process or application the payment transaction was just processed through and metadata coded therein for searchability of the transactional record 314 within a distributed ledger.

In some embodiments, the system may comprise at least one additional miner node 312. The system may require that pending transactions 310 be validated by a plurality of miner nodes 312 before becoming authenticated blocks on the block chain. In some embodiments, the systems may impose a minimum threshold number of miner nodes 312 needed to verify each pending transaction. The minimum threshold may be selected to strike a balance between the need for data integrity/accuracy versus expediency of processing. In this way, the efficiency of the computer system resources may be maximized.

Furthermore, in some embodiments, a plurality of computer systems are in operative networked communication with one another through a network. The network may be a system specific distributive network receiving and distributing specific network feeds and identifying specific network associated triggers. The network may also be a global area network (GAN), such as the Internet, a wide area network (WAN), a local area network (LAN), or any other type of network or combination of networks. The network may provide for wireline, wireless, or a combination wireline and wireless communication between devices on the network.

In some embodiments, the computer systems represent the nodes of the block chain, such as the miner node or the like. In such an embodiment, each of the computer systems comprise the block chain, providing for decentralized access to the block chain 302 as well as the ability to use a consensus mechanism to verify the integrity of the data therein.

Various embodiments provide a system operatively connected with a block chain distributed network and for using the block chain distributed network for facilitating network authentication for real-time interactions using pre-authorized data records. Embodiments receive, at a node of a block chain distributed network, an authentication record associated with a user of a data network; access a distributed ledger, wherein the distributed ledger is updated based on communications from the block chain distributed network; determine, from the distributed ledger, whether the authentication record includes effective authentication token; if so, authenticate the user using the authentication token; if not request credentials from the user; receive the credentials from the user; authenticate the credentials; and create an authenticated token based on the authenticated credentials; and record the authenticated token as an updated authentication record on the distributed ledger.

Referring now to FIG. 4, a flowchart illustrates a method 400 for network authentication for real-time interactions using pre-authorized data records according to embodiments of the invention. The first step, as represented by block 410, is to receive, at a node of a blockchain distributed network, an authentication record associated with a user of a data network. The next step, as represented by block 420, is to access a distributed ledger that is updated based on communications from the blockchain distributed network. The next step, as represented by block 430, is to determine whether the authentication record includes an effective authentication token. If the authentication record does not include an effective authentication token, then the system request credentials from the user, as represented by block 440. Next, as represented by block 450, the system receives and authenticates the credentials received from the user, thereby creating an authenticated token. Finally, as represented by block 460, the system records the authentication token as an updated authentication record on the distributed ledger.

In various embodiments, the system may receive a request from a user to perform a transaction, and in response to receiving the request to perform the transaction, the system accesses the distributed ledger to determine whether the authentication record includes an effective authentication token. This may be done by, for example, communicating with a server of an administering entity to confirm that the authentication record is effective. In some embodiments, the authentication token may be confirmed by applying a key to the token to determine whether the output after application is as expected. If so, the user may be authenticated to perform the transaction. In some embodiments, the authentication record may enable the system to authenticate the user fully or partially based on the effective authentication token being present. In some cases, partial additional authentication will be required.

In various embodiments, in response to determining that the authentication record includes an effective authentication token, the system establishes authentication of the user for a predetermined time period, whereby subsequent transaction requests received within the predetermined time period do not require re-authentication.

In some embodiments, in response to determining that the authentication record includes an effective authentication token, the system establishes authentication of the user for a predetermined time period, whereby subsequent transaction requests received within the predetermined time period do not require complete re-authentication. In some of these instances, for example, the system in response to receiving a second transaction request associated with a second transaction, requesting less than full authentication credentials for re-authentication of the user; receiving the less than full authentication credentials from the user; and re-authenticating the user to perform the second transaction.

In various embodiments, the system, in response to determining that the authentication record includes an effective authentication token, establishes authentication of the user for a predetermined type of transaction, whereby subsequent transaction requests received that match the predetermined type of transaction do not require complete re-authentication.

In some embodiments, the system records the updated authentication record on a second distributed ledger different than the distributed ledger.

In some embodiments, the system accesses a set of rules configured to cause the system to access the updated authentication record to facilitate performance of a real-time interaction.

In some embodiments, the system utilizes a smart contract to determine whether a distributed ledger entry (e.g., the authentication record) includes a completely or partially pre-authenticated token. In other words, a smart contract may be implemented that accesses the entry in the ledger and reviews it to determine whether it is a validly pre-authenticated record. In some embodiments, the logic, code or smart contract that controls determination of whether the authentication record is valid is included within the authentication record itself. In some cases, the logic or code or smart contract that facilitates use of the authentication record in conjunction with a real-time or near real-time payment is part of the authentication record itself or is stored elsewhere.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein. In some embodiments, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent | | |
|---|---|---|---|
| | Application | | |
| Docket Number | Ser. No. | Title | Filed On |
| 8334US1.014033.3189 | To be | REAL-TIME | Con- |
| | assigned | NETWORK | currently |
| | | PROCESSING | herewith |
| | | NUCLEUS | |
| 8335US1.014033.3190 | To be | REAL-TIME | Con- |
| | assigned | DATA | currently |
| | | PROCESSING | herewith |
| | | PLATFORM WITH | |
| | | INTEGRATED | |
| | | COMMUNICATION | |
| | | LINKAGE | |
| 8336US1.014033.3191 | To be | REAL TIME | Con- |
| | assigned | DATA | currently |
| | | PROCESSING | herewith |
| | | PLATFORM FOR | |
| | | RESOURCES ON | |
| | | DELIVERY | |
| | | INTERACTIONS | |
| 8337US1.014033.3192 | To be | INTERNET-OF- | Con- |
| | assigned | THINGS ENABLED | currently |
| | | REAL-TIME | herewith |
| | | EVENT | |
| | | PROCESSING | |

What is claimed is:

1. A system operatively connected with a block chain distributed network and for using the block chain distributed network for facilitating network authentication for real-time interactions using pre-authorized data records, the system maintained by an entity, the system comprising:
a memory device; and
a processing device operatively coupled to the memory device, wherein the processing device is configured to execute computer-readable program code to:
receive, at a node of a block chain distributed network, an authentication record associated with a user of a data network;
access a distributed ledger, wherein the distributed ledger is updated based on communications from the block chain distributed network;
determine, from the distributed ledger, whether the authentication record includes effective authentication token;
if so, authenticate the user using the authentication token;
if not:
request credentials from the user;
receive the credentials from the user;
authenticate the credentials; and
create an authenticated token based on the authenticated credentials; and
record the authenticated token as an updated authentication record on the distributed ledger.

2. The system of claim 1, wherein the processing device is further configured to execute computer-readable program code to:
receive a requests from a user to perform a transaction; and
in response to receiving the request to perform the transaction, access the distributed ledger to determine whether the authentication record includes effective authentication token.

3. The system of claim 2, wherein the processing device is further configured to execute computer-readable program code to:
in response to determining that the authentication record includes an effective authentication token, establish authentication of the user for a predetermined time period, whereby subsequent transaction requests received within the predetermined time period do not require re-authentication.

4. The system of claim 2, wherein the processing device is further configured to execute computer-readable program code to:
in response to determining that the authentication record includes an effective authentication token, establish authentication of the user for a predetermined time period, whereby subsequent transaction requests received within the predetermined time period do not require complete re-authentication.

5. The system of claim 4, wherein the processing device is further configured to execute computer-readable program code to:
in response to receiving a second transaction request associated with a second transaction, requesting less than full authentication credentials for re-authentication of the user;
receiving the less than full authentication credentials from the user; and
re-authenticating the user to perform the second transaction.

6. The system of claim 2, wherein the processing device is further configured to execute computer-readable program code to:
in response to determining that the authentication record includes an effective authentication token, establish authentication of the user for a predetermined type of transaction, whereby subsequent transaction requests received that match the predetermined type of transaction do not require complete re-authentication.

7. The system of claim 1, wherein the processing device is further configured to execute computer-readable program code to:
record the updated authentication record on a second distributed ledger different than the distributed ledger.

8. The system of claim 1, wherein the processing device is further configured to execute computer-readable program code to:
access a set of rules configured to cause the system to access the updated authentication record to facilitate performance of a real-time interaction.

9. A computer program product for using a block chain distributed network for network authentications for real-time interaction using pre-authorized data records, wherein the computer program product comprises at least one non-transitory computer readable medium comprising computer readable instructions, the instructions, when executed by a computer processor, cause the computer processor to:
receive, at a node of a block chain distributed network, an authentication record associated with a user of a data network;
access a distributed ledger, wherein the distributed ledger is updated based on communications from the block chain distributed network;
determine, from the distributed ledger, whether the authentication record includes effective authentication token;
if so, authenticate the user using the authentication token;
if not:
request credentials from the user;
receive the credentials from the user;
authenticate the credentials; and
create an authenticated token based on the authenticated credentials; and
record the authenticated token as an updated authentication record on the distributed ledger.

10. The computer program product of claim 9, wherein the computer readable instructions further cause the computer processor to:
receive a requests from a user to perform a transaction; and
in response to receiving the request to perform the transaction, access the distributed ledger to determine whether the authentication record includes effective authentication token.

11. The computer program product of claim 10, wherein the computer readable instructions further cause the computer processor to:
in response to determining that the authentication record includes an effective authentication token, establish authentication of the user for a predetermined time period, whereby subsequent transaction requests received within the predetermined time period do not require re-authentication.

12. The computer program product of claim 10, wherein the computer readable instructions further cause the computer processor to:
in response to determining that the authentication record includes an effective authentication token, establish authentication of the user for a predetermined time period, whereby subsequent transaction requests received within the predetermined time period do not require complete re-authentication.

13. The computer program product of claim 12, wherein the computer readable instructions further cause the computer processor to:
in response to receiving a second transaction request associated with a second transaction, requesting less than full authentication credentials for re-authentication of the user;
receiving the less than full authentication credentials from the user; and
re-authenticating the user to perform the second transaction.

14. The computer program product of claim 10, wherein the computer readable instructions further cause the computer processor to:
in response to determining that the authentication record includes an effective authentication token, establish authentication of the user for a predetermined type of transaction, whereby subsequent transaction requests received that match the predetermined type of transaction do not require complete re-authentication.

15. The computer program product of claim 9, wherein the computer readable instructions further cause the computer processor to:
record the updated authentication record on a second distributed ledger different than the distributed ledger.

16. The computer program product of claim 9, wherein the computer readable instructions further cause the computer processor to:
access a set of rules configured to cause the system to access the updated authentication record to facilitate performance of a real-time interaction.

17. A computer implemented method for using the block chain distributed network for network authentication for real-time interactions using pre-authorized data records, the computer implemented method comprising:
receiving, at a node of a block chain distributed network, an authentication record associated with a user of a data network;
accessing a distributed ledger, wherein the distributed ledger is updated based on communications from the block chain distributed network;
determining, from the distributed ledger, whether the authentication record includes effective authentication token;
if so, authenticating the user using the authentication token;
if not:
requesting credentials from the user;
receiving the credentials from the user;
authenticating the credentials; and
creating an authenticated token based on the authenticated credentials; and
recording the authenticated token as an updated authentication record on the distributed ledger.

18. The computer implemented method of claim 17, further comprising:
receiving requests from a user to perform a transaction; and
in response to receiving the request to perform the transaction, accessing the distributed ledger to determine whether the authentication record includes effective authentication token.

19. The computer implemented method of claim 18, further comprising:
in response to determining that the authentication record includes an effective authentication token, establishing authentication of the user for a predetermined time period, whereby subsequent transaction requests received within the predetermined time period do not require re-authentication.

20. The computer implemented method of claim 19, further comprising:
in response to determining that the authentication record includes an effective authentication token, establishing authentication of the user for a predetermined time period, whereby subsequent transaction requests received within the predetermined time period do not require complete re-authentication.
